(19) United States
(12) Patent Application Publication
(10) Pub. No.: US 2005/0083675 A1
(43) Pub. Date: Apr. 21, 2005

(54) Illumination module with receptacle and liquid crystal display with same

(75) Inventors: Chung-Sung Huang, Miao-Li (TW); Sheng-Ming Wen, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 10/966,248

(22) Filed: Oct. 15, 2004

(30) Foreign Application Priority Data
Oct. 15, 2003 (TW) 92128500

(51) Int. Cl. F21V 7/04

(52) U.S. Cl. 362/31

(57) ABSTRACT

An illumination module (10) for emitting light beams includes a substrate (20) having a bottom plate (21) and a pair of opposite side walls (22), a plurality of pairs of holders (23) integrally formed on the bottom plate, and a plurality of linear light sources (30). Each holder defines a slot (231), with the holder elastically holding one end of a corresponding linear light source in the slot. Each linear light source has two wires (40, 40′) extending from two opposite ends thereof. The side walls define a plurality of apertures (50) therein, for receiving the wires of the linear light sources therethrough. The linear light sources with the wires can be quickly and safely removed from the substrate for replacement. The illumination module provides good mechanical performance, easy manufacturing and assembly, and reduced costs.

### BACKGROUND OF THE INVENTION

1. Field of the Invention

The invention generally relates to an illumination module with a receptacle for accommodating illumination units, and to a liquid crystal display (LCD) device incorporating the illumination module.

2. Prior Art

In general, an LCD device has the advantages of thinness, light weight and low power consumption. For these reasons, LCDs devices are widely utilized in various types of electronic equipment, from pocket calculators to large-scale office automation equipment.

The larger an LCD, the more linear light sources must be provided therein in order to brightly light it. Even when numerous light sources need to be incorporated into large-scale LCDs, it is desirable that manufacturing of the LCDs is as efficient as possible. Each linear light source is generally a Cold Cathode Fluorescence Lamp (CCFL).

U.S. Pat. No. 6,330,150 issued to Soon-Dong Kim discloses a system for exchanging lamps of an LCD (see FIGS. 4 and 5). The system 100 includes a liquid crystal panel 13, a frame 12, and a plurality of lamps 17. A plurality of generally rectangular through holes 131 is defined in an upper beam of a frame of the liquid crystal panel 13. A rubber plate 18 is elastically attached on a lateral surface of a head portion of each lamp 17. The lamps 17 are inserted through the through holes 131, and engaged therein by elastic compression of the rubber plates 18 therein. In addition, each through hole 131 is bounded by an inwardly sloping slanted surface 132, so that the corresponding lamp 17 is easily inserted into the through hole 131. Each lamp 17 is electrically connected to a power system (not shown) through a free wire 133 extending from the head portion. When each lamp 17 is pulled out from the corresponding through hole 131, the elastic force between the rubber plate 18 and side walls bounding the through hole 131 is released, thereby allowing replacement of the lamp 17.

Even though the system 100 enables exchanging of the lamps 17 of the LCD, the system 100 encounters some problems as follows:

First, the lamps 17 and the wires 133 cannot be firmly engaged with the liquid crystal panel 13. According to the system 100, each lamp 17 is engaged in the corresponding through holes 131 of the liquid crystal panel 13 substantially by means of the elastic force between the rubber plate 18 and the slanted surface 132 bounding the through hole 131. The elastic force between the rubber plate 18 and the slanted surface 132 is easily released by vibration or shock. In addition, a bottom end 172 of each lamp 17 is not secured, which renders the lamps 17 themselves unstable and liable to shatter. Furthermore, the wires 133 are not secured with the liquid crystal panel 13, and are simply randomly located in the LCD. In assembly of the LCD, the loose wires 133 may hinder the assembly process, and the wires 133 are liable to be damaged. These problems mentioned reduce the efficiency and yield of the system 100, and increase costs commensurately.

### SUMMARY OF THE INVENTION

An object of the present invention is to provide an illumination module that has high mechanical performance, is easy to manufacture, and has low costs.

According to one aspect of the present invention, an illumination module comprises a receptacle, a plurality of linear light sources, and a plurality of pairs of holders. The receptacle has a bottom plate and a plurality of opposite side walls extending from the bottom plate. Each linear light source has two wires extending from two opposite ends thereof. The holders are integrally formed in the receptacle. Each holder defines a slot, with the holder elastically holding one end of a corresponding linear light source in the slot. The side walls define a plurality of apertures therein, for receiving the wires of the linear light sources therethrough. The linear light sources with the wires can be quickly and safely removed from the substrate for replacement. The illumination module provides good mechanical performance, easy manufacturing and assembly, and reduced costs.

Other objects, advantages, and novel features of the present invention will become more apparent from the following detailed description when taken in conjunction with the accompanying drawings; in which:

### BRIEF DESCRIPTION OF THE DRAWINGS

FIG. 1 is a simplified, exploded isometric top view of a preferred embodiment of an illumination module according to the present invention;

FIG. 2 is an assembled, isometric bottom view of the illumination module according to the present invention;

FIG. 3 is an exploded, cutaway isometric view of an LCD according to the present invention, the LCD incorporating the illumination module according to the present invention;

FIG. 4 is a simplified, exploded isometric view of a conventional LCD; and

FIG. 5 is an enlarged view of a circled portion V of FIG. 4.

### DESCRIPTION OF THE PREFERRED EMBODIMENTS

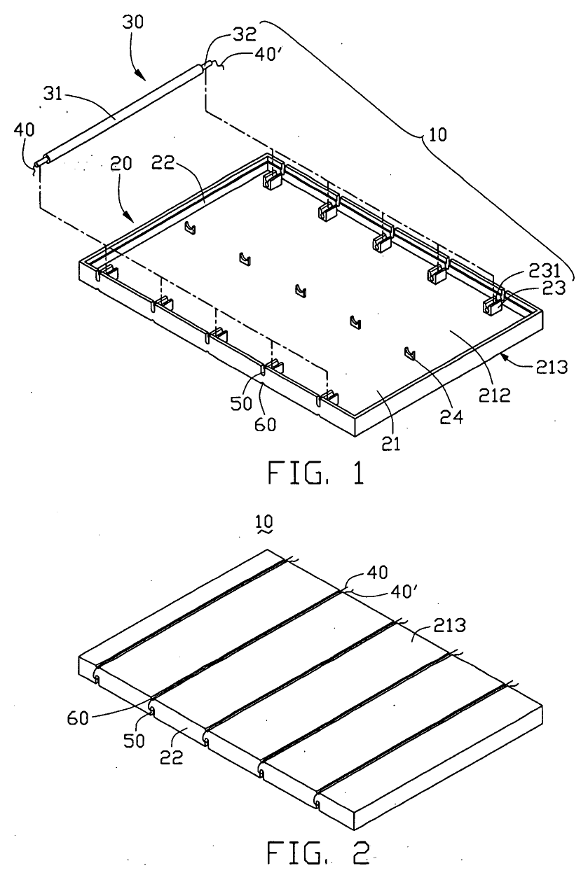

Referring to FIG. 1, a preferred embodiment of an illumination module 10 according to the present invention includes a plurality of linear light sources 30 (only one shown), and a substrate 20 shaped as a box-like frame. A plurality of pairs of spaced apart holders 23 are integrally formed on the substrate 20.

In the illustrated embodiment, there are five pairs of holders 23 for five corresponding linear light sources 30. The substrate 20 functions as a receptacle of the illumination module 10, and is for accommodating the linear light sources 30 therein. The substrate 20 has a bottom plate 21, and four side walls 22 formed around a periphery of the bottom plate 21. The bottom plate 21 has a main inner surface 212 and an outer bottom surface 213.

The holders 23 are made from elastic material, such as silicon rubber. Each holder 23 defines a slot 231, for elastically holding one end of a corresponding linear light source 30. That is, each pair of holders 23 elastically holds a respective linear light source 30. In addition, a clip 24 made of elastic and transparent material is disposed on the inner surface 212 midway between each pair of holders 23, for elastically clasping the corresponding linear light source 30. Thus, the linear light source 30 is firmly secured in the substrate 20.

Each linear light source 30 has a main body 31, and two electrodes 32 extending respectively from two opposite ends of the main body 31. A diameter of each electrode 32 is less than a diameter of the main body 31. Two wires 40, 40′ respectively extend out from distal ends of the electrodes 32. A power source (not shown) connects to the electrodes 32 through the wires 40, 40′, for providing power to the linear light source 30.

The side walls 22 of the substrate 20 have a plurality of apertures 50 defined therein, for extension of the wires 40, 40′ of the linear light sources 30 therethrough. Each aperture 50 corresponds to a holder 23, and is deep enough to ensure that the corresponding wire 40, 40′ can freely extend out of the substrate 20 without being damaged.

Referring to FIG. 2, a plurality of transverse grooves 60 corresponding to the apertures 50 is defined in the bottom surface 213 of the bottom plate 21, for accommodating the wires 40 of the linear light sources 30 respectively. Thus, terminal ends of the wires 40, 40′ of each linear light source 30 are positioned together at a same lateral side of the substrate 20, for easy attachment to a connector (not shown).

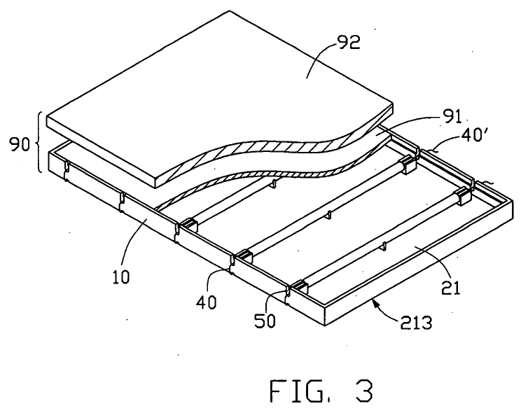

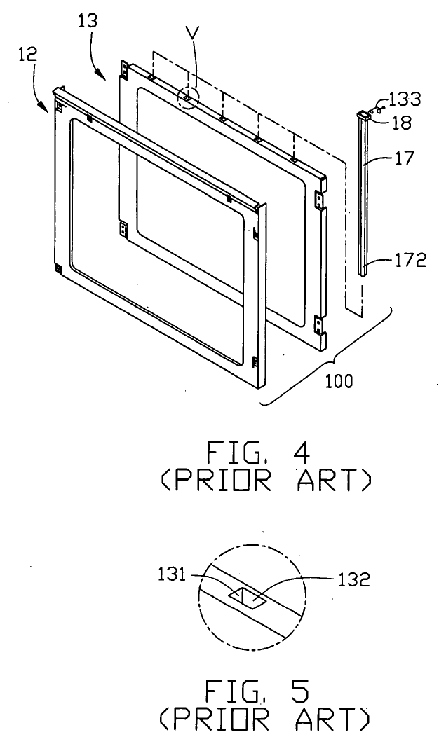

Referring to FIG. 3, in assembly of the illumination module 10, the linear light sources 30 are securely retained in the holders 23 and the clips 24. The holders 23 maintain elastic compression around the ends of the linear light sources 30. The wires 40, 40′ extend out through the corresponding apertures 50. The wires 40 are received and retained in the corresponding grooves 60. Furthermore, a diffusing plate 91 and a liquid crystal display panel 92 can be arranged on the illumination module 10 in that sequence from bottom to top, the whole assembly thereby constituting a liquid crystal display 90.

With the above-described structure of the illumination module 10, each pair of holders 23 firmly retains the corresponding linear light source 30 therebetween. The linear light source 30 is prevented from being accidentally detached from the holders 23. In addition, the wires 40, 40′ are securely held by the substrate 20. Furthermore, when assembling the illumination module 10, the linear light sources 30 can be quickly and safely engaged in the holders 23, and the wires 40, 40′ can be quickly and conveniently secured in the substrate 20. Similarly, when disassembling the illumination module 10, the linear light sources 30 and the wires 40, 40′ can be quickly and safely removed from the substrate 20. Thus, the illumination module 10 provides good mechanical performance, easy manufacturing, assembly and maintenance, and reduced costs.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An illumination module for emitting light beams, comprising:
a receptacle having a bottom plate and a pair of opposite side walls;
a linear light source having wires extending from opposite ends thereof; and
a pair of holders integrally formed in the receptacle, each of the holders defining a slot and elastically holding one end of the linear light source in the slot;
wherein the side walls define apertures therein, for the apertures receiving the wires of the linear light source therethrough.

2. The illumination module as claimed in claim 1, wherein the bottom plate of the substrate defines a groove in a bottom surface thereof, the groove receiving either of the wires therein.

3. The illumination module as claimed in claim 1, wherein the linear light source comprises a main body and two electrodes extending respectively from two opposite ends of the main body, a diameter of each of the electrodes being less than a diameter of the main body.

4. The illumination module as claimed in claim 1, wherein the holders are made of silicon rubber.

5. The illumination module as claimed in claim 1, further comprising a clip on the bottom plate clasping the linear light source.

6. The illumination module as claimed in claim 5, wherein the clip is made of elastic and transparent material.

7. An illumination module receptacle for accommodating a plurality of linear light sources, comprising:
a substrate having a bottom plate and a pair of opposite side walls; and
a plurality of clips formed on the substrate for elastically holding the linear light sources;
wherein the side walls define a plurality of apertures therein, for receiving wires of the linear light sources therethrough.

8. A liquid crystal display comprising:
a substrate having a bottom plate, and a pair of opposite side walls spaced from each other in a direction;
a linear light source having a pair of wires extending from thereof two opposite ends which are adjacent to the side walls, respectively; and
a pair of clips formed in the substrate for elastically holding said two ends of the linear light source, respectively;
wherein the one of said pair of wires extends from one corresponding end and across the bottom plate along said direction, and reaches the other end to join the other of said pair of wires.

9. The liquid crystal display as claimed in claim 8, wherein said one of the pair of wires extends outside of the bottom plate
